(19) United States
(12) Patent Application Publication
(10) Pub. No.: US 2012/0062555 A1
(43) Pub. Date: Mar. 15, 2012

(54) VIRTUAL PERSONALIZED FITTING ROOM

(75) Inventors: Kimberley Jane O'CONNOR, Hoevelaken (NL); Paul O'CONNOR, Hoevelaken (NL)

(73) Assignee: FRUITFUL INNOVATIONS B.V., Hoevelaken (NL)

(21) Appl. No.: 13/212,213

(22) Filed: Aug. 18, 2011

Related U.S. Application Data
(63) Continuation of application No. PCT/EP2010/051942, filed on Feb. 16, 2010.
(60) Provisional application No. 61/153,318, filed on Feb. 18, 2009.

(51) Int. Cl. G06T 15/00

(52) U.S. Cl. 345/419

(57) ABSTRACT

A system is disclosed for reducing, without fully eliminating, the need for the use of fitting rooms. The system comprises a first database, which contains a data set capturing defining features of a person. The system further comprises a second database comprising defining features of an appearance enhancing accessory.

The system comprises a means for combing data from the two databases. The combined data are used to compute an integrated picture of the person provided with the accessory, and the picture is displayed to the person.

The first database may be contained in a portable computing device, such as a PDA. The second database may be held in a memory attached to the accessory, such as a chip.

### CROSS-REFERENCE TO RELATED APPLICATIONS

This is a continuation of PCT/EP2010/051942 filed on 16 Feb. 2010, which claims priority from United State provisional application number 61/153,318 filed 18 Feb. 2009, the contents of both applications are hereby incorporated by reference in their entireties.

### BACKGROUND OF THE INVENTION

1. Field of the Invention

The invention relates generally to a system for providing an accurate three-dimensional representation of a person provided with an appearance enhancing accessory, and more particularly to such a system making use of defining features of the person.

2. Description of the Related Art

Computer modeling has been proposed as a tool for providing a customer with a properly fitting garment. One approach has been to feed the customer's measurements into a CAD system, and use the measurement data to cut and sew a garment of the proper fit and size. A second approach has been to use a customer's measurements to select a properly fitting garment from a supply of “off-the-rack” items.

EP 1 959 394 A2 discloses a system for providing a computer simulated picture of a person wearing a garment. The computer simulated picture is based on two-dimensional representations of the person and the garment, respectively. By necessity, the system uses generalized approximations for converting the two 2-dimensional representations to a computer simulated 3-dimensional picture.

JP 2004133876A discloses a system that aims at completely eliminating the need for a fitting room. According to the English language abstract, the customer loads face data and size data into a database. Her personal data are combined with garment-related data to produce a picture of the person wearing the garment. If the person decides to purchase the garment she places an on-line order for it.

U.S. Pat. No. 6,473,671 B1 to Yan discloses a sophisticated computer program for using a customer's measurements, which may be obtained from a body scan, in producing a garment that fits the customer properly. The document is exclusively focused on providing a garment that has the right fit.

U.S. Pat. No. 6,546,309 B1 to Gazzuolo discloses a system that aims at completely eliminating the need for a fitting room. The system provides size prediction, fit analysis, and fit visualization. The visual fit model is built from a generic 3-D model.

The prior art fails to fully address the complexity of the in-store garment selection process. On the one hand, is it not realistic to eliminate the opportunity for the customer to see and feel the fabric and expect the result to have a high satisfaction frequency. Similarly, it is overly ambitious to try to fully eliminate the need for a real fitting room, as the ultimate satisfaction depends in part on emotional factors that defy digitalization. On the other hand, the prior art fails to take into account factors other than size and fit.

Thus, there is a particular need for a system aimed at reducing, rather than eliminating, the need for the use of a fitting room in selecting an appearance enhancing accessory. There is a further need for providing such a system that is capable of reflecting anticipated or desired changes in a person's appearance.

### BRIEF SUMMARY OF THE INVENTION

The present invention addresses these problems by providing a system for providing an accurate three-dimensional representation of a person provided with an appearance enhancing accessory, said system comprising:

a) a first database comprising a data set capturing defining features of the person;

b) a second database comprising a data set capturing defining features of the appearance enhancing accessory;

c) means for combining data from the first database and data from the second database into an integrated picture representing the person provided with the appearance enhancing accessory;

d) means for displaying the integrated picture of step c).

### DETAILED DESCRIPTION OF THE INVENTION

The present invention is based on an analysis of the selection process used by the large majority of customers in selecting a garment or other fashion item from a store's inventory. It will be understood that the customer may be male or female. Although generally referred to herein by the female gender, this should not be taken as a limitation because the system of the invention applies equally well to the male customer.

In the store, the customer scans the display racks with her eyes for items that may be of interest. When a particular item catches her eye, she will take it off the rack and feel the texture and drape of the fabric. If she likes what she sees, she may hold the garment in front of her and observe herself in a mirror. She will then select the size that she thinks she needs, perhaps including one size up and one size down, and will go to the fitting room to try on the garment. To reduce the number of trips to the fitting room, she may select a number of garment items to try on. Most stores, however, put a limit on the number of items a customer may take to the fitting room at one time.

In the fitting room the customer will not only judge the garment by its fit. To the contrary, she wants to know how she looks in the garment. She will seek answers to questions such as, “does this make me look tall short, skinny, fat, pudgy, pale”, and the like. She will also want to see whether the garment accentuates what she considers to be her positive attributes, and downplay or hide what she considers to be her negative features. She will also want to know whether the garment reveals the outline of her undergarments.

The customer will not be satisfied just knowing what she looks like in the garment seen in a front view. She will want to know how she looks in profile and from the rear. Although fitting rooms are provided with multiple mirrors to address this issue, it is very difficult for the customer to see herself from all angles without turning her shoulders and craning her neck, which makes it very difficult for her to judge what she really looks like when standing straight. Many customers have developed the habit of shopping in the company of a friend or relative, who is relied upon to provide additional input. However, it may be difficult for such a friend or relative to provide an opinion at the appropriate level of frankness without straining the relationship.

It is clear that the prior art approaches to the above process leave much to be desired. Firstly, most of the prior art systems aim at completely eliminating the in-store experience. In doing so, they eliminate the opportunity to see and feel the fabric before making a purchase decision. By eliminating this important step, the prior art systems create a high risk of customer dissatisfaction, which results in a high rate of returned purchases, which is costly to the retailer.

Another drawback of the prior art systems is that they are geared at answering the question “what does a person having my size look like in this garment?” (or, in the case of JP 2004 133876A, “what does a person having my size and my face look like in this garment?”). As explained herein above, the fitting room experience is expected to answer many more questions, many of which are not addressed by the prior art systems. Basically, the customer wants an answer to the question “how do I look into his garment?”. The better a virtual system is able to answer this question, the better it will be positioned to replace the actual fitting room experience.

The present invention is based on the understanding that it is not possible to fully replace the in-store shopping experience, because there is no replacement yet for the ability to feel the texture and drape of a fabric. This being the case, it is also not necessary to completely eliminate the need for a use of a fitting room. It is, however, highly desirable to provide a system allowing the customer to prescreen garments so as to dramatically reduce the number of garments that need to be tried on in a real fitting room.

This need is addressed by providing a system for providing an accurate three-dimensional representation of a person provided with an appearance enhancing accessory, said system comprising:

a) a first database comprising a data set capturing defining features of the person;

b) a second database comprising a data set capturing defining features of the appearance enhancing accessory;

c) means for combining data from the first database and data from the second database into an integrated picture representing the person provided with the appearance enhancing accessory;

d) means for displaying the integrated picture of step c).

Although the invention will be described primarily with reference to the appearance enhancing accessory being a garment, the system of the invention is suitable for use with a wide variety of such accessories. Basically, the system of the invention can be used with any accessory that modifies the appearance of a person. The term “appearance enhancing accessory” as used herein refers to any item that changes the appearance of a person. In the case of garments, the definition is not limited to outer garments because undergarments may very well change the appearance of a person, even when worn under an outer garment; moreover the customer will be interested in knowing how the undergarment changes her appearance when worn without being covered by an outer garment.

The definition of appearance enhancing accessory also applies to fashion accessories such as belts, shawls, hair bands, and other such items.

The term also covers non-garment related items, such as hairstyles, hair color, shades of cosmetic products, shoe styles, and prostheses.

An important aspect of the system of the invention is the set of defining features of the person. The defining features define the person, as distinguished from a generalized representation of the person, in terms that are relevant to the appearance enhancing accessory. For example, if the accessory is prosthesis, important defining features include the physical handicap the prosthesis is intended to correct, as well as a definition of the limb or other body part that the prosthesis is intended to replace. If the appearance enhancing accessory is a wig, the defining features of the person may include the shape and size of the skull, the amount of hair, if any to be covered by the wig; the shape of the person's face; facial features, such as the size of the forehead, the position of the eyes, the color of the eyes, the shape and size of the nose, the shape and size of the mouth, and similar features.

If the appearance enhancing accessory is an undergarment, the defining features of the person must at least include a body scan of the person, and a representation of the person's face. It is however very important to provide a measure of the amount of adipose tissue present on the person's body. The person's body mass index, defined as a person's weight in kilograms (kg) divided by their height in meters (m) squared, may provide a useful approximation. It may be preferred, however, to provide more sophisticated measurements, such as obtained with calipers, in those areas of the body that are intended to come into contact with the undergarment.

In particular if the appearance enhancing accessory is an outer garment, it may be desirable to provide more than one body scan of the person. One body scan may represent the person not wearing any undergarments; a second body scan may represent the person wearing a particular style of undergarment, such as a corset or a push up bra, as such undergarments may have a significant effect on the body shape of person. Likewise, it may be desirable to provide different body scans representing the person wearing no shoes or flat shoes, and one representing the person wearing high heels, which can have a significant effect on the posture of the person.

Because the customer will be interested to know what she looks like wearing the appearance enhancing accessory, as opposed to what someone looking more or less like her would look like, it is important to include as many defining features relating to the person's appearance into the first database as possible. Examples include skin tone, hair style, hair color, facial features, and the like.

It is desirable to provide the customer with the capability of manipulating some of the data present in the first database. For example, the customer may contemplate a change of hair style, and may want to know what she would look like with the new hair style. Her interest may be general, but may also be very specific in combination with a particular garment, such as a wedding dress. Similarly, the customer may plan to gain or lose a certain amount of weight, and will be interested in knowing what she would look like if she went ahead with her plan. For this purpose the first database may be provided with an algorithm designed to predict the body shape of the person if certain changes in the body weight were to be made.

Desirably the first database contains data relating to personal preferences of the customer. Such data may be entered by the customer, for example when she first sets up the database, and amended or expanded with time. Personal preference data may be amplified by data extracted from the history of use of the database. For example, the database could track the items the customer has tried on, and use this history for updating and/or refining the customer's preference profile. The usefulness of these data can be improved further by identifying which of the items that were tried on in the past were actually purchased.

Desirably the system offers suggestions to the customer. It is very important that suggestions being made are perceived as helpful and to the point. Helpful suggestions contribute to a positive experience, whereas unhelpful or unwelcome suggestions are merely annoying. It is important, therefore, to provide a filter in the algorithm controlling the system, so that only few and highly relevant suggestions are made. In the alternative, the system may be set up so as to offer suggestions only if the customer expresses an interest in receiving them.

Preferably, suggestions made by the system are based on combined data from the first and the second database. For example, the second database may contain data on items that allow themselves to be coordinated with the item being tried on. The system retrieves these data from the second database, and preference data from the first database. The system then makes, or offers to make, those suggestions that fit the customer's preference profile.

Although the first database and the second database may reside in one computing system, it is contemplated that in many cases the first database will reside in a memory system that is separate from the memory system containing the second database.

By way of example, the first database may be kept in a memory of a PDA or other portable device. Examples include digital personal assistants, mobile phones, MP3 players, and the like.

The second database may be kept in a memory that is physically attached to the appearance enhancing accessory. For example, the second database may be contained in a chip that is attached to the accessory, such as a garment. The chip may be a radio frequency identifying chip, the use of which is becoming increasingly common in the garment industry.

In an alternate embodiment, the second database is stored on a server, which can be accessed from a terminal located in the store. A customer may call up the second database associated with a particular appearance enhancing accessory for example by entering a code identifying the accessory, or by scanning a barcode that is attached to the accessory.

The system contains a means for combining data from the first database with data from the second database. For this purpose, data from the first database may be read into a computing device associated with the second database, or vice versa. For example, the customer may connect her portable computing device to a terminal in the store, allowing the terminal to read data from the first database into a temporary memory of the stores computer. Alternatively, the customer's portable computing device may read data from the second database into the memory of the portable computing device.

The specific means for combining the data from the two databases is not an essential part of the invention. What's relevant is that the system creates a computing device that, at least temporarily, contains data from both the first database and the second database. These data are used to compute an integrated picture representing the person provided with the appearance enhancing accessory. Importantly, the computed picture takes into account as many of the defining features of the person as are relevant to the specific appearance enhancing accessory. As a result, the integrated picture provides answers to as many of the fitting room questions as possible.

The integrated picture representing the person provided with the appearance enhancing accessory is displayed in a way that the customer can see it. For example, the picture may be displayed on the screen of the customer's PDA or mobile phone, or it may be displayed on the screen of a terminal located in the store. In a preferred embodiment, the picture can be rotated so that the customer can see herself from various angles.

In a further preferred embodiment, the system provides narrative comments alerting the customer to specific details. For example, the screen may display a narrative comment saying “this dress tends to exaggerate the hips”, or “this top makes the neck look shorter”. One source of the narrative commons is the second database. Desirably, data from the first database are taken into account to select only those comments that are relevant to that particular customer.

An important aspect of the resident invention is the comprehensiveness and the quality of the data in both the first and second database. The quality of the data in the second database is generally controlled by the manufacturer and/or the retailer of the appearance enhancing accessory. It is in the interest of the manufacturer and the retailer to provide a second database that is as comprehensive as possible and as accurate as possible. Doing so will enhance the shopping experience of the customer and will increase the likelihood of customer satisfaction, thereby providing a reliable base of repeat business.

The first database is controlled by the customer, and it is in her interest to make the first database as comprehensive and reliable as possible. In general, the customer is not in a position to provide sophisticated data, such as body scans. A vendor of a system of the present invention may choose to apply body scans for a modest fee, or free of charge, in order to encourage early adoption of the system. Likewise, retailers may provide body scans for a low fee or free of charge for the same reason. With proper provisions for protecting the customers' privacy, retailers and manufacturers will benefit from providing the body scans as it allows them to build a database of a cross-section of their customer base. The database could be used to make adjustments to standard sizes in order to better reflect the actual body shapes of their customer base. Similarly, the database could be used to help predict the size distribution of the sales of a particular garment.

It will be appreciated that the more comprehensive the data sets in the two data bases, the more information can be offered by means of the integrated picture and/or the corresponding narrative comments. It is not intended to fully replace the use of a real fitting room, as technology has not advanced to the point that it can answer some of the less tangible questions that the customer will have. However, the system is effective in reducing the need for the real fitting room, which enhances the shopping experience for the customer and reduces the waiting lines in front of the fitting rooms.

Although the invention has been described mainly this reference to garments, it will be understood that the invention can also be used by other professions that are active in the field of changing the appearance of their customers. For example, a dentist may use the system to show a patient the expected effect of a teeth whitening treatment; an orthodontist many use the system to show the expected effect of an orthodontic treatment; a hairstylist can use the system to show a customer what she will look like with a different hairstyle or different hair color; and the like.

Thus, the invention has been described by reference to certain embodiments discussed above. It will be recognized that these embodiments are susceptible to various modifications and alternative forms well known to those of skill in the art.

Many modifications in addition to those described above may be made to the structures and techniques described herein without departing from the spirit and scope of the invention. Accordingly, although specific embodiments have been described, these are examples only and are not limiting upon the scope of the invention.

In an alternate embodiment the system of the invention is used to facilitate mail order shopping. The term “mail order shopping” as used herein encompasses any form of shopping in which the shopper selects an item based on a store sample or a pictorial representation of the item in, for example, a catalog or on a web page. The selected item is shipped to the shopper from a remote location.

Many mail order shoppers order a large number of items so they may try them on at home. Most of the items are then returned to the mail order company, purchasing only a small number of the items, if any. This practice puts a significant cost burden on the mail order company, because a large portion of their stock is unavailable to them at any given point in time, they incur shipping for items being sent out and returned, and returned items frequently need to be repackaged. In some cases returned items are no longer sellable. Yet, mail order companies generally accommodate this practice, and accept the cost burden as a cost of doing business.

This system of the invention permits the shopper to make a pre-selection of the items she is potentially interested in, narrowing down the options and thereby reducing the number of items having to be shipped to the customer. The number of items returned is dramatically reduced, providing significant cost savings to the mail order retailer, while enhancing the customer's shopping experience.

In yet another embodiment the system of the invention is used as a video game, in which the player of the game composes an avatar, which can be outfitted with a variety of appearance enhancing accessories.

One aspect of the game is the selection of the avatar. For example, the avatar can be a realistic representation of the person playing the game, as it would be when the system is used in a real shopping situation. The game element in this case resides in “trying on” appearance enhancing accessories, such as garments, that the gamer would never seriously consider purchasing, being too expensive, too extravagant, too revealing, etc.

In an alternate embodiment the game permits the gamer to define an avatar by modifying her appearance, for example correcting her perceived imperfections and/or emphasizing her attractive features. Similarly, the avatar can be based on appearance modifying measures the gamer is contemplating. The appearance enhancing measure can be transient, such as a change in hair style and/or hair color, or the measure can be permanent or semi-permanent, such as weight loss, weight gain, cosmetic surgery, or a tattoo. The avatar can then be outfitted with realistic garments or with garments the gamer would never seriously consider purchasing, being too expensive, too extravagant, too revealing, etc.

Similarly, the avatar can be based on what the gamer expects her appearance to be in the future. Specifically, prepubescent girls can create an avatar representing the young woman they expect to become. The system can contain software creating a more or less scientific prediction of the gamer's future appearance. Alternatively the gamer can be allowed to freely fantasize about her future appearance. In a hybrid version the software creates an avatar based on a prediction of the gamer's future appearance, which the gamer then modifies according to her hopes and desires, or her whim of the moment.

In yet another embodiment the game contains avatars of celebrities, which the gamer can outfit with appearance enhancing accessories, such as garments. Optionally the game can be set up so as to permit the gamer to modify the appearance of the celebrity, such as by changing the celebrity's weight, hair color, hair style, etc.

In a particularly preferred embodiment the system permits a retailer to develop a profile of a shopper, based on at least one of (i) her appearance; (ii) her frequency of use of the system;(iii) the items selected for viewing in the system; (iv) and items actually purchased. If the system is equipped with the game feature described above it is desirable to provide for a means for monitoring when the system is used for gaming, so that such use does not alter the shopper's profile. For example, the system can contain a “game mode” and a “shopping mode”. Use of the system in game mode will be ignored for purposes of developing or updating a shopper's profile.

The shopper's profile can be used for targeted marketing in any number of ways. For example, the retailer can send the shopper an e-mail or text message when specific new items are arriving in the store, or when certain items are being offered at a discounted price. The profile is used to predict which items the shopper is likely to be interested in. In a preferred embodiment the shopper is invited to answer a number of questions aimed at refining her profile, such as her hobbies, her favorite vacation destinations (beach, city, snow, etc.), her favorite colors, and the like.

In a specific embodiment the system is present on a device, such as a PDA or a Smartphone that is equipped with a global positioning system (GPS). Information from the GPS relating to the shopper's geographic location is used by the system to alert her when she is in the proximity of a retail store offering items she is likely interested in. In a specific embodiment a retailer issues a product-specific alert, for example in the form of a text message, when she is in the proximity of the retail store. It is desirable to permit the shopper to switch off the alert feature, so as to avoid unwanted alerts when the shopper is simply driving by a shopping mall.

In a specific embodiment the system acts as an interface with an internet platform. The platform may support an internet community, for example a community of companies and designers in the fashion industry and of individuals interested in fashion. Individuals can, for example, upload an avatar with a specific appearance enhancing accessory. This can be an accessory they have recently purchased, in which case the purpose of uploading the avatar can be to share their excitement over the purchase with others. Or the accessory can be one they are contemplating purchasing, in which case the purpose of uploading the avatar can be inviting the comments and opinions of others.

Companies and designers can use the community for gauging interest in specific designs or colors. Individuals can use the system to “try on” the new design, and use the result as a basis for their feedback to the company or designer.

Accordingly, an embodiment of the invention is an internet community comprising a plurality of users of the system of the invention.

What is claimed is:

1. A system for providing an accurate three-dimensional representation of a person provided with an appearance enhancing accessory, said system comprising:
(a) a first database comprising a data set capturing defining features of the person;
(b) a second database comprising a data set capturing defining features of the appearance enhancing accessory;
(c) means for combining data from the first database and data from the second database into an integrated picture representing the person provided with the appearance enhancing accessory;
(d) means for displaying the integrated picture of step (c).

2. The system of claim 1 wherein the defining features of the person comprise the facial features of the person.

3. The system of claim 1 wherein the defining features of the person comprise at least one body scan of the person.

4. The system of claim 3 wherein the defining features of the person comprise at least two body scans, each body scan representing the person in a specific position.

5. The system of claim 1 wherein the defining features of the person comprise a hairstyle.

6. The system of claim 1 wherein the defining features of the person comprise a physical handicap.

7. The system of claim 1 wherein the defining features comprise a body mass index.

8. The system of claim 1 wherein the appearance enhancing accessory is a garment.

9. The system of claim 1 wherein the appearance enhancing accessory is a hair style.

10. The system of claim 9 wherein the appearance enhancing accessory further comprises a hair color.

11. The system of claim 1 wherein the appearance enhancing accessory is a prosthesis.

12. The system of claim 1 wherein at least the first database is contained in a portable computing device.

13. The system of claim 1 wherein at least the first database can be modified by the person.

14. The system of claim 13 wherein the first database is modified to reflect actual changes in the defining features of the person.

15. The system of claim 13 wherein the first database is modified to reflect anticipated changes in the defining features of the person.

16. The system of claim 13 wherein the first database is modified to reflect desired changes in the defining features of the person.

17. The system of claim 1 wherein the first database comprises data related to the person's personal preferences.

18. The system of claim 17 wherein the data related to the person's personal preferences comprise a history of use of the system.

19. The system of claim 17 capable of making suggestions to the person based at least in part on the person's personal preferences.

20. The system of claim 1 wherein the second database is held in a memory associated with a sample of the appearance enhancing accessory.

21. The system of claim 1 wherein the first database is pre-loaded in a computing device, and data from the second database are scanned into the computing device.

22. Use of the system of claim 1 in mail order shopping.

23. Use of the system of claim 1 in a video game.

24. Use of the system of claim 1 by a retailer to form a profile of a shopper.

25. Use of the system of claim 1 as an interface to a social network.
